(19) United States
(12) Patent Application Publication
(10) Pub. No.: US 2010/0038176 A1
(43) Pub. Date: Feb. 18, 2010

(54) CONVEYOR CHAIN LUBRICATION SYSTEM

(75) Inventors: Richard A. Moen, Rockford, MI (US); Scott A. Johnson, Holton, MI (US); William Preble, Fremont, MI (US)

Correspondence Address: CAROL WILSON;BP AMERICA INC., MAIL CODE 5 EAST, 4101 WINFIELD ROAD, WARRENVILLE, IL, 60555, US

(73) Assignee: BP CORPORATION NORTH AMERICA INC., Warrenville, IL (US)

(21) Appl. No.: 12/512,463

(22) Filed: Jul. 30, 2009

Related U.S. Application Data
(60) Provisional application No. 61/088,511, filed on Aug. 13, 2008.

(51) Int. Cl. F16N 27/00

(52) U.S. Cl. 184/7.4

(57) ABSTRACT

A conveyor chain lubricating system and method in which lubricant is applied effectively and efficiently and in response to the condition of the chain by monitoring the level of lubrication required for the chain and in response to such level, synchronizing the speed of the dispensing valve and dispensing means with the speed of the chain's movement and the predetermined position of the pin with respect to the dispensing outlet, to accurately deposit a shot of lubricant onto each consecutive pin for a sufficient number of chain revolutions for the required level of lubrication to be attained.

This application claims the benefit of U.S. Provisional Patent Application No. 61/088,511 filed Aug. 13, 2008.

### BACKGROUND OF THE INVENTION

The present invention relates to the application of lubricant to a conveyor chain, particularly to the controlled effective and efficient application of lubricant in response to the condition of the chain.

Endless conveyors are used in many industries to move articles. The chains which drive the conveyors are well known. They are made up of a plurality of links which are each formed of a pair of parallel link plates joined at each end by a cylindrical rollers, which engage the notches of sprocket wheels that drive or are driven by the chains. Adjacent links are pivotally joined at the rollers. Each roller typically has a link pin at its axis surrounded by an annular bushing. The pins have a head at one end and a lock pin at the other to hold the adjacent links together. In industries such as the glass industry, such conveyors are employed to carry fiberglass materials, for example, fiberglass bats of building insulation through high temperature ovens during its manufacture. Typically such ovens employ conveyors driven by endless chains of conventional design which themselves pass through the high temperature of the ovens.

Conveyor chains of this common type require continuous lubrication to prevent the wear of the contacting surfaces between the pins, the bushings and the rollers. With many uses of conventional chains, the occasional application of lubricant to the chain is sufficient, and application of the lubricant to the entire chain, including pins, bushings, collars and links, is common. Typically, petroleum based lubricating oils are adequate, but when such chains operate in a high temperature environment, ordinary oils will burn and lose their lubricating properties. This has required the use of specialty oils such as high temperature synthetic oils that can retain their lubricating properties in such high temperature environments.

High temperature synthetic lubricating oils are considerably more expensive than ordinary petroleum based lubricating oils. Furthermore, even these oils, when used in high temperature ovens, require constant reapplication, since even they will dissipate and need to he replenished. Because of the size of the chains, often fifty to three hundred feet in length, when they are continuously and totally wetted with the lubricating oil, consumption of the oil is high, and significantly contributing to the overall manufacturing operation. Furthermore, as the oils encounter high temperatures, vapors and smoke are generated in proportion to the amount of oil applied to the chains. The vapors and smoke that are produced must be exhausted away from the atmosphere and personnel within the manufacturing plant, and requires expensive air cleaning equipment to prevent the smoke and vapors from being released into the external atmosphere.

To solve some of the problems set forth above, it has been proposed in the prior art to limit the amount of lubricant applied to the conveyor chains by selective application of the oil to only the pin and bushing assemblies of the chains. This has been done by intermittently dispensing discrete quantities of oil on the chain as it passes a lubrication station in an attempt to apply oil only at the junctures of the links. In doing so, prior art systems have met with only limited success.

The chains of conveyors that transport materials often move at varying speeds, slow or fast, for example, up to 300 feet per minute. At 300 feet per minute, with chains of links that are, for example, six inches in length, 600 pins per minute, or 10 pins per second, pass any given lubrication station. In addition, since the target area is generally small, the pins are adjacent the lubrication station little more than 1/10th of a second. This has made the application of the concept of applying lubricant only to the pins difficult to practice. In that the loss of lubrication can result in costly damage to the conveyor, or at least reduced chain life and higher power consumption, such systems of the prior art have had limited acceptance in the industry.

Efforts to time the dispensing of drops of lubricant and synchronize the application of the discrete amounts of lubricant with the pin positions have been proposed. It has also been proposed, for example in Mattcheck, U.S. Pat. No. 5,186,280, to lubricate only every one of a predetermined number of pins that pass the lubricant dispensing point. In theory, spacing the drops more widely should make it easier to trigger the initiation of the dispensing cycle, particularly where the system is otherwise slow to respond. However, the problem of accurately focusing of the dispensed fluid droplet onto the point of the chain at which it is needed at varying chain speeds is not solved by this concept. Furthermore, this system may require numerous revolutions of the chain before each consecutive pin in the chain is lubricated, and some pins may become dry and unlubricated before lubricant is applied to them.

Furthermore, since the chains can be very long, it is often difficult to determine the exact number of links/pins/bushings in a revolution of a chain. Even if the exact number is known, as the chain wears, due to wear at the pin or bushing, the chain will in fact grow in length. When the chain “grows” to a point that the tensioning device reaches its limit, some chain links need to be removed to compensate for the chain wear and lengthening. Under other circumstances, links may be added to a chain revolution. It is at this point in time when the controller of U.S. Pat. No. 5,186,280 does not know that links have been removed from or added to a chain revolution, and thus some links may be over lubricated or may be under lubricated.

In addition, the goal of lubrication is to create a boundary layer between two metal surfaces to prevent wear or friction, thus reducing or maintaining chain motor drive amperage. This boundary layer of lubricant needs to be replenished every so often, depending on a number of factors. However the controller of U.S. Pat. No. 5,186,280 has no idea how long it takes before the chain links/pins/bushings need to be re-lubricated. Since the lubrication system of U.S. Pat. No. 5,186,280 is constantly lubricating, and merely skipping wheels all day long, over lubrication may easily occur.

Consequently it is highly desirable to apply lubricant effectively and efficiently to each consecutive chain links, pins and bushings of the chain within a single revolution of the chain regardless of the speed of chain movement, and to control application of the lubricant in response to the condition of the chain.

### SUMMARY OF THE INVENTION

The present invention is a conveyor chain lubricating system for effectively and efficiently depositing discrete shots of lubricant onto chain links, pins and bushings of a continuously moving conveyor chain, the system comprising: a lubricating fluid reservoir having a chain lubricating fluid contained therein; a dispensing outlet adjacent and spaced from the conveyor chain; a fluid conducting line extending from the reservoir to the aforesaid dispensing outlet; a pump connected in the aforesaid line for pumping lubricating fluid from the reservoir and along the line at a predetermined pressure; a valve means connected in the aforesaid line between the pump and the outlet for opening and closing the line to the flow of fluid from the pump toward the outlet in response to a control signal; a dispensing means for dispensing a discrete shot of lubricating fluid from the dispensing outlet in response to the opening of the aforesaid line to the flow of fluid; sensor means for generating a timing signal related to a predetermined position of a pin of the conveyor chain with respect to the aforesaid outlet; and controller means for monitoring the level of lubrication required for the chain and responsive both to timing signals from the sensor means and to the level of lubrication required for the chain, for generating the aforesaid control signal to synchronize the speed of the valve means and dispensing means with the chain speed and the aforesaid predetermined position of the pin, and to activate the valve means to cause a momentary flow of lubricating fluid through the aforesaid line and to cause a discreet predetermined amount of lubricant to be deposited from the outlet accurately onto each consecutive pin for a sufficient number of revolutions of the chain for the required level of lubrication to be attained.

The present invention is also a method of effectively and efficiently applying a lubricating fluid onto pins that pivotally interconnect links of a conveyor chain comprising: supplying a chain lubricating fluid from a reservoir; pumping the lubricating fluid along a fluid supply line at a predetermined pressure to a valve; sensing the predetermined position of a pin of the conveyor chain with respect to a dispensing outlet and generating a timing signal in response thereto; monitoring the level of lubrication required for the chain; synchronizing the speed of the valve with the speed of the chain and the aforesaid predetermined position of the pin and opening the valve in response both to the timing signal and to the level of lubrication required for the chain to deliver the pressurized fluid further along the line to dispense a discrete predetermined amount of the lubricating fluid from an outlet located close to and spaced from the chain, accurately onto each consecutive pin for sufficient number of revolutions of the chain for the required level of lubrication to be attained.

### BRIEF DESCRIPTION OF THE DRAWINGS

For a more complete understanding of this invention reference should now be made to the embodiments illustrated in greater detail in the accompanying drawings and described below by way of an example of the invention.

In the drawing(s):

FIG. 1 is a schematic perspective drawing of one preferred embodiment of a conveyor chain lubricating system according to principles of the present invention.

FIG. 2 is a top view of a portion of a conveyor chain of the system of FIG. 1.

FIG. 3 is a cross sectional view through a conveyor chain of the system of FIG. 1 along the line 3-3 of FIG. 2 and with shots of lubricant being dispensed from nozzles clamped in a nozzle bracket.

It should be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted. It should be understood, of course, that the invention is not necessarily limited to the particular embodiments illustrated herein.

### DETAILED DESCRIPTION OF THE INVENTION

The primary objective of this invention is to provide efficient and effective and controlled lubrication to a continuously moving, variable speed conveyor chain or chains utilizing a lubricant. This system is designed to apply the right amount of oil, at the right time, and in the correct location on the chain at varying speeds of the chain's revolution.

A key to proper lubrication lies with knowing when and how often to re-lubricate. In the context of the present invention, a lubrication cycle is defined by one lubrication period followed by a non-lubrication period. A lubrication period is defined by the number of complete revolutions of the chain, in which each and every chain link, pin and bushing has been lubricated. A non-lubrication period is one in which no lubrication takes place.

Proper lubrication has an important effect on motor drive amperage and conveyor speed. Consequently, drive amperage or chain speed can be used to estimate the proper lubrication cycle for a conveyor chain, and can be measured by a transducer or chain sensor, respectively. A given drive amperage or chain speed can be related to one of a number of levels of lubrication that are necessary for proper lubrication of the conveyor chain. Each such level contains a specific lubrication scheme including: maximum drive amperage or maximum chain speed, a lubrication period of a certain number of chain revolutions, and a non-lubrication period (measured in seconds, minutes, or hours). A deviation from a given level can occur when the motor drive amperage or chain speed exceeds the maximum listed amperage value or speed value for that particular level. With each increase in level, an elevated degree of lubrication is employed. An elevated lubrication scheme is one in which additional lubricant is applied to the conveyor chain links, pins and bushings, and is achieved by either increasing the number of chain lubrication revolutions, or decreasing the non-lubrication period, or a combination of both Thus, the number of chain revolutions in succession could be increased, or by decreasing the length of the non-lubrication period within a given lubrication cycle or a given period of time, there is a relatively increased number of chain revolutions within that cycle or period of time. Additional lubricant is thereby applied to reduce drive amperage or chain speed and to return to normal operating range, and thus a lower level or normal lubrication scheme. On the other hand, the drive amperage or chain speed may indicate that a reduced level of lubrication is adequate for the chain in which case a lower level of lubrication or even a period of non-lubrication is started. Thus, the number of chain resolutions in succession could be decreased, or by increasing the length of the non-lubrication period within a given lubrication cycle or a given period of time, there is a relatively decreased number of chain revolutions within that cycle or period of time.

The system and method of this invention provides a system that dispenses measured lubricant shots onto the chain links, pins and bushings of a continuously moving variable speed conveyor chain from a dispensing outlet. Lubricant fluid is delivered from a pumping station through a supply line at a fixed pressure to one or more dispensing outlets located adjacent to and directed towards the chain at the point where lubrication is needed. The pumping station consists of pumping apparatus such as, but not limited to, a gear pump and motor. The pump is of sufficient capacity, and the supply lines are sufficiently sized, to allow fluid to be supplied by the pump at a predetermined minimum flow rate and minimum pressure. Flow from this line is controlled by a valve, typically a solenoid valve, located downstream from the pumping station, which controls the flow of lubricant to the dispensing outlet. Connected to the valve is a manifold of one or more dispensing means that meter the amount of lubricant dispensed. In the present invention, the pumping station is located near the conveyor and the valve and dispensing means are located proximate to, and typically no more than 4 feet from the point of lubrication. The valve is energized by a signal from the variable speed controller located near the pumping station and described herein below. The signal is synchronized to the speed of the chain and to the position of the conveyor pins/bushing and links so that measured amounts of lubricant are delivered to specific links, pins and bushings in the chain at varying speeds of the chain's revolution. A dispensing outlet is connected to the outlet of each dispensing means and is directed toward the chain links, pins and bushings. The dispensing means dispenses lubricant only when the valve is energized, which allows metered fluid to be dispensed through the dispensing outlet. When the valve is de-energized, flow of the lubricant through the line and to the dispensing means stops. Preferably, the valve is a 3-way, 2-position solenoid, and when the solenoid is de-energized, the dispensing means is allowed to relieve pressure in the dispensing means through the 3-way valve back to the pumping station through a relief line. Relieving this pressure allows the dispensing means to reset for the next lubricant shot during a lubrication cycle.

The dispensing means dispenses a discrete metered shot of lubricant from the dispensing outlet onto the surfaces to be lubricated and is positioned sufficiently close to the chain as to accurately dispense the metered shot onto the point of the chain to be lubricated. Generally, one dispensing means is employed for each dispensing outlet or nozzle. Devices that are suitable for use as the dispensing means include any device that can positively dispense the amount of lubricant that is dispensed through the dispensing outlet. For example, U.S. Pat. No. 5,186,280 disclosed the use of a check valve. Preferably the dispensing means is an injector such as those provided by Lincoln as the SL-32 model or by Farval as the FL-32 model. An injector, like a syringe, holds only a certain amount of lubricant, which amount can be adjusted, and will only dispense that amount of lubricant for each chain link, pin and bushing. Each such injector contains a manual adjustable setting for the volume of lubricant that is to be dispensed. The valve needs to be energized sufficiently long for the lubricant to be forced from the injector. At the dispensing outlet, one or more nozzles direct fluid towards the chain links, pins and bushings. The nozzles may be formed to make a conical shape at the tip to increase the velocity of the shot. Larger or smaller openings may be cut in the nozzles depending on shot velocity required, which can be dependent on the speed of the conveyor chain, or lubricant viscosity, or the temperature.

The dispensing nozzle functions as a barrel to guide the measured shot to the pre-determined area on the chain. Preferably four nozzles are provided, each connected to the dispensing means which is located as close to the point of lubrication as possible. The two outer nozzles are directed towards the chain links where two link plates join, and the two inner nozzles are directed towards the chain pins/bushings. A metered amount of lubricant is delivered through each nozzle. In a preferred embodiment, each lubrication station features a lubricator sled that houses one or more nozzles on an adjustable nozzle clamping device. Each sled is connected to a lubrication station via a spring loaded clamping device, which acts to protect the sled and nozzle from damage caused by debris or damaged chain. Each sled is adjustable vertically and perpendicularly to the vertical plane from the lubrication station. The lubrication sled can be rotated 360 degrees for easy alignment to chain elevation and can be used as a break-away device during extreme chain debris or catastrophic chain failure. Preferably each lubrication sled also contains a set of high velocity air knives that are used to keep nozzles clear and free of debris. Nozzles often collect debris that may prevent a shot of lubricant from reaching critical chain lubrication points. Preferably air knives are scheduled to automatically dispense high velocity air bursts, aimed at the nozzle tips, for short periods of time at user programmed time intervals. Air knives are controlled by a common 2-way high flow rate solenoid valve and are activated by the controller and monitored for adequate air pressure by means of a pressure transducer for adequate air pressure.

A critical aspect of proper lubrication is timing and aiming a “shot” of lubricant to a specific target. This requires that the associated nozzles and a chain sensor are in proper placement with respect to the target pin at the precise moment when the lubricant is to be deposited. When the sensor detects a lubrication target, such as a chain pin, sprocket tooth, or encoder, etc., the associated lubrication nozzles must be positioned over the middle of the lubrication target. If the nozzles are even slightly misaligned from the target, the resulting “shot” of oil may miss a lubrication target.

The pumping and dispensing of lubricant are controlled and synchronized with the speed of the chain and position of the lubrication target in the lubrication station by a controller such as a multi-function real-time controller or microprocessor or a PLC or other computer. During a lubrication period, in which lubricant is being delivered to a number of chain links, pins and bushings, the controller utilizes logic to accurately dispense lubricant to a target location on each chain link, pin and bushing, with varying chain speeds. Logic is installed in the programmable automation controller, running at real-time processing speeds, to ensure that lubricant is accurately dispensed at the precise moment when the target pin is in the lubrication station.

A polynomial of D=C₂P²+C₁P+C₀, where D is the delay in seconds, C₂, C₁, C₀ are constants, and P is the pulse time in seconds between timing signals from the sensor. This equation is utilized for ensuring that the timing between the timing signal received and the resulting lubricant dispensed are in direct correlation for proper lubrication. For each and every timing signal or pulse, a corresponding valve delay D is calculated. This is done on-the-fly for each and every chain link, pin and bushing in a chain revolution for proper lubrication accuracy. Each constant Cₓ in the equation can be unique or different for each size or pitch of chain being lubricated.

The controller also monitors at least one of the chain motor drive amperage or the chain speed to thereby estimate the level of lubrication required for the chain. In response to both the level of lubrication required and the timing signals from the sensor, the controller generates a control signal to synchronize the speed of the valve with the chain speed and to energize the valve to cause a momentary flow of the lubricant through the line and to cause a discrete predetermined amount of lubricant from the dispensing outlet to be deposited accurately onto each consecutive chain link, pin and bushing for a sufficient number of revolutions of the chain for the required level of lubrication to be attained. Thereby the controller determines the proper lubrication period, for the chain. The controller also activates the air knives.

With the present invention, approximately fifty percent less lubricant is needed to lubricate a chain of a conveyor than with several systems of the prior art. In addition, the chains are better and more effectively lubricated, experiencing less friction and requiring less power to drive them than with systems of the prior art, yielding longer chain life and lower operating energy costs. Further, substantially lower amounts of vapor and smoke from the heated oil are produced in plants utilizing the present invention than with prior systems, in most cases reducing the exhaust requirements and eliminating much of the cost of cleaning the air upon its exhaust into the outside atmosphere.

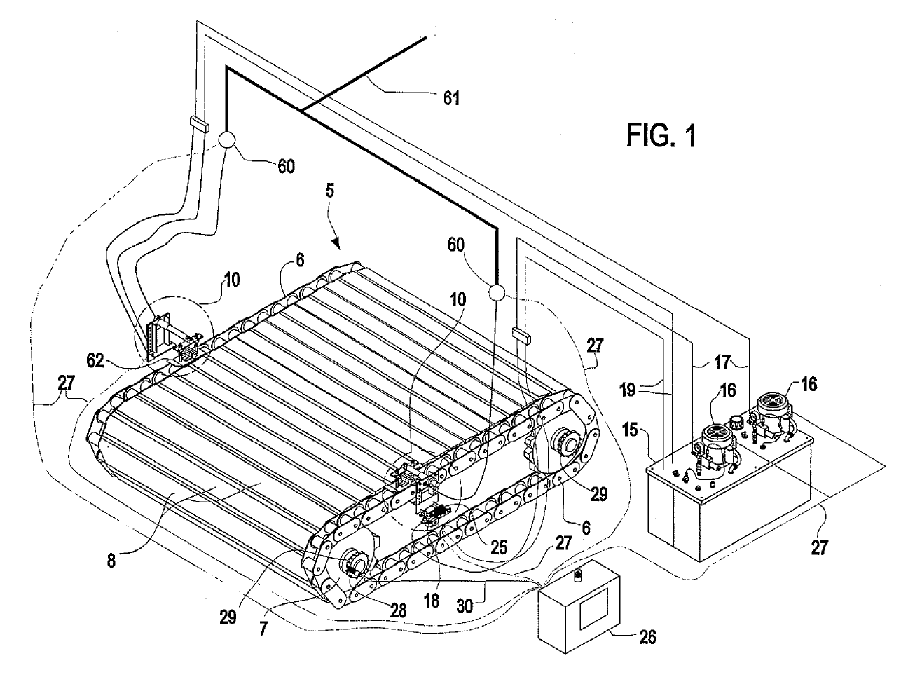

A preferred embodiment of the conveyor chain lubricating system of the present invention is illustrated in FIG. 1. The conveyor 5 is made up of two drive chains 6, which are driven by the sprockets, only the ends of which are illustrated in FIG. 1. The sprockets are mounted with one on each end of a rotatable shaft (not shown) to rotate together and with the shaft. One of the shafts of the conveyor 5 is a drive shaft powered by a motor (not shown), which drives the chains 6. The other shafts are idler shafts that are driven by the chain 6. Plates 8 are bolted (not shown) at their opposite ends to brackets 9 that are rigidly connected to the corresponding inner links 41,42 on the interior sides of the two chains 6 of the conveyor 5.

Two lubrication stations 10 are located opposite one another for lubricating the chains 6 of the conveyor 5. Each lubricating station 10 is supplied with lubricating fluid from a common reservoir 15 by means of separate pumps 16. Each pump 16 preferably provides a flow capacity of about 0.4 gallon per minute, and is operated at a controlled pressure of approximately 800 to 1000 pounds per square inch by a pressure regulator valve (not shown) located at the pump 16. Suitable pumps include Model 1002496, manufactured by Haldex Barnes.

Each of the pumps 16 is connected through a supply line 17, preferably of rigid ⅜ inch outside diameter or larger tubing of standard wall thickness, to the inlet port of each of two solenoid valves 18, located on opposite sides of the conveyor 5, each in proximity of less than four feet to the chains 6 to be lubricated. The solenoid valves 18 are preferably three-way direct acting directional solenoid valves such as Parker 7000 Series, or a similar high speed solenoid valve. Each of the valves 18 has a drain port (not shown) connected by a relief line 19, which connects back to the reservoir 15. Each solenoid valve 18 also has an outlet port (not shown) that connects through a short length of tube to the input of a manifold (not shown) having one or more outlets. To each outlet is connected an injector 25, the outlet of each of which is connected to a discharge tube 51 which serves as a discharge nozzle.

The solenoid valves 18 operate in response to signals from a programmable controller 26 which is programmed to supply control signals by means of control lines 27 to, and thereby activates, each of the solenoid valves 18. A suitable controller 26 is, for example, Compact Fieldpoint Model cFP-2110 manufactured by National Instruments.

A sensor 28 is provided for the lubrication system, adjacent a sprocket wheel 29 or equivalent on the axis of a shaft. The sprocket wheel 29 may be a steel sprocket having the same number of teeth as the sprocket 7 to cooperate with a magnetic pickup of the sensor 28, or to otherwise carry detectable index marks such as magnets or other machine readable indicia, that will cause the sensor 28 to generate a timing signal corresponding to the presence of a pin of the chain 6 adjacent the nozzles 51 at a predetermined position within or immediately before a lubrication station 10, and to do so for each consecutive pin. The timing signals are communicated from the sensor 28 to the controller 26 by input line 30.

The controller 26 is programmed to use the timing signals from the sensor 28 in order to determine from them the speed of the conveyor chains 6 The controller 26 also monitors at least one of the chain motor drive amperage transducers. Using either the speed or drive amperage, the controller 26 thereby estimates the level of lubrication required for the chain. Then in response to a timing signal and in response to the estimate of the level of lubrication required for the chains 6, if any lubrication is required, the controller 26 activates and synchronizes the solenoid valves 18 and injectors 25 to the speed of the chains 6 and the position of the pin in the lubrication station 10, and a shot of lubricant is deposited accurately on the pin. If the controller 26 estimates that the chains 6 require no re-lubrication at that time, the controller 26 does not activate the solenoid valves 18 and injectors 25, and a non-lubrication period commences.

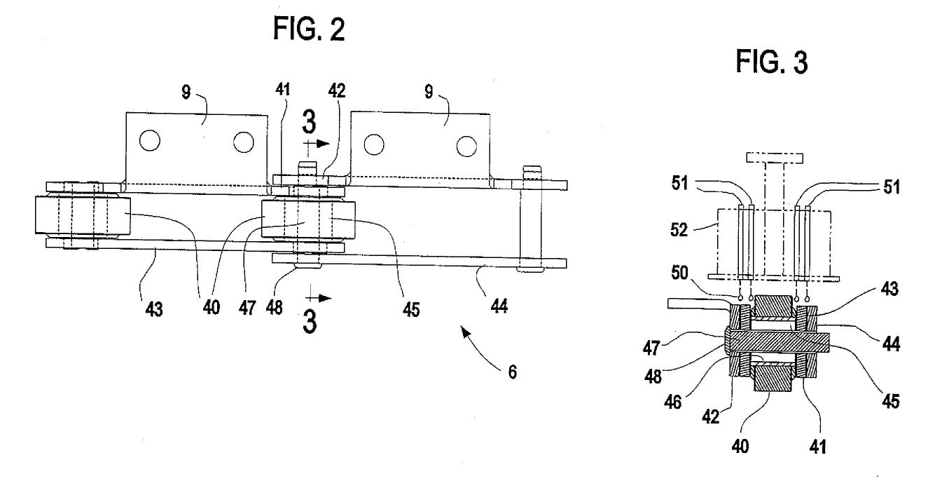

The placement of the shots of lubricant on the chain 6 is illustrated in FIGS. 2 and 3. Referring to FIG. 2, a chain 6 includes a plurality of rollers 40 and a corresponding plurality of links 41, 42, 43, 44, the interior links 41, 42 supporting the brackets 9, and the exterior links 43, 44 include alternating inner 43 and outer links 44. The rollers 40 each have an axial hole 45 therethrough to carry an annular bushing 46. Each bushing 46 has a hole therethrough coaxial with the roller 40 and through which a link pin 47 is inserted. Each pin 47 has a head 48 on one end and a hole on the other end through which a key pin (not shown) is inserted. The inner links 41, 43 on each side of the chain have holes at the opposite ends thereof that slip over and are supported on a shoulder on the outer surfaces of the bushings 46 at the sides of the rollers 40. The outer links 42, 44 on each side of the chain 6, have holes at the opposite ends thereof that slip over and are supported on the pins 47 of the adjacent rollers 40 against the sides of the bushings 46, between the bushings 46 and heads 48 of pins 47 on the exterior side of the chain 6, and between the bushings 46 and key pins on the interior side of the chain 6.

FIG. 3 is a cross sectional view along plane 3-3 in FIG. 2 and through the roller 40, the links 41, 42, 43, 44, the bushing 46, the pin 47 and its head 48. Also shown are lubricant shots 50 being dispensed from the four injectors (not shown) and then through the four dispensing tubes or nozzles 51. The nozzles 51 are clamped in place by a nozzle bracket 52 on the lubrication sled 62. Shots 50 of lubricant are dispensed into gaps between the chain links 41, 42,43, 44, the chain pin 47 and the bushing 46.

After each ejection of lubricant onto the chain 6, the three-way solenoid 18 is de-activated by the controller 26, flow of the lubricant from the solenoid 18 to the injector 25 and dispensing nozzles 51 is stopped, and is recirculated through the solenoid 18 through the relief line 19 back to the reservoir 15. When the pressure in the injectors has dissipated, and upon the next timing signal, the system is ready to dispense lubricant onto the chain 6 again.

During non-lubrication periods, air supply located in air supply line 61 flows to air knives (not shown) located on the lubrication sleds 62 when the controller 26 energizes solenoids 60 for a predetermined time period to clean any debris from the nozzles 51.

In an alternative embodiment to that illustrated, a plurality of chain lubrication system sections, as for example, an upper chain lubrication system and a lower chain lubrication system, or another combination of two or more chain lubrication system sections, may be supplied from the same pump.

From the above description, it is apparent that the objects of the present invention have been achieved. While only certain embodiments have been set forth, alternative embodiments and various modifications will be apparent form the above description to those skilled in the art and are within the spirit and scope of the present invention.

Accordingly, what is claimed is:

1. A conveyor chain lubricating system for effectively and efficiently depositing discrete shots of lubricant onto pins that pivotally interconnect links of a continuously moving conveyor chain, the system comprising:
a lubricating fluid reservoir having a chain lubricating fluid contained therein;
a dispensing outlet adjacent and spaced from the conveyor chain;
a fluid conducting line extending from the reservoir to the aforesaid dispensing outlet;
a pump connected in the aforesaid line for pumping lubricating fluid from the reservoir and along the line at a predetermined pressure;
a valve means connected in the aforesaid line between the pump and the outlet for opening and closing the line to the flow of fluid from the pump toward the dispensing outlet in response to a control signal;
a dispensing means for dispensing a discrete shot of lubricating fluid from the dispensing outlet in response to the opening of the aforesaid line to the flow of fluid;
sensor means for generating a timing signal related to a predetermined position of a pin of the conveyor chain with respect to the aforesaid outlet; and
controller means for monitoring the level of lubricating required for the chain, and responsive both to timing signals from the sensor means and to the level of lubrication required for the chain, for generating the aforesaid control signal to synchronize the speed of the valve and dispensing means with the chain speed and the aforesaid predetermined position of the pin, and to activate the valve means to cause a momentary flow of lubricating fluid through the aforesaid line and to cause a discreet predetermined amount of lubricant to be deposited from the dispensing outlet accurately onto each consecutive pin for a sufficient number of revolutions of the chain for the required level of lubrication to be attained.

2. The conveyor chain lubricating system of claim 1 wherein the at least one dispensing outlet is stationary and adjacent and spaced from the conveyor chain in fixed relationship therewith.

3. The conveyor chain lubricating system wherein the controller means is operative to energize the valve means to open the line and to close the line before the next control signal is generated.

4. The conveyor chain lubricating system wherein the valve means are located along the fluid conducting line in close proximity to the dispensing outlet.

5. The conveyor chain lubricating system wherein the reservoir is located remote from the conveyor chain.

6. The lubricating system of claim 1 wherein the controller means monitors the motor drive amperage of the conveyor chain to estimate the level of lubrication required for the chain.

7. The lubricating system of claim 1 wherein the controller means monitors the speed of the conveyor chain to estimate the level of lubrication required for the chain.

8. The lubricating system of claim 1 wherein when the controller means estimates that the conveyor chain requires a greater level of lubrication, lubricant is deposited onto each consecutive pin for an increased number of revolutions of the chain in succession or for a relatively increased number of chain revolutions within a given cycle of lubrication and non-lubrication.

9. The lubricating system of claim 1 wherein when the controller means estimates that the conveyor chain is adequately lubricated, the controller means causes lubricant to be deposited on each consecutive pin for a reduced number of chain revolutions or causes a period of non-lubrication to start.

10. The lubricating system of claim 1 which comprises additionally a lubricant fluid recirculating loop means including a return line connecting the dispensing means and the reservoir when the fluid flow in the fluid conducting line to the outlet is closed.

11. A method of applying a lubricating fluid to pins that pivotally interconnect links of a conveyor chain comprising:
supplying a chain lubricating fluid from a reservoir;
pumping the lubricating fluid along a fluid supply line at a predetermined pressure to a valve and dispenser;
sensing the predetermined position of a pin of the conveyor chain with respect to a dispensing outlet and generating a timing signal in response thereto;
monitoring the level of lubrication required for the chain;
synchronizing the speed of the valve and dispenser with the speed of the chain and the aforesaid predetermined position of the pin and opening the valve and dispenser in response to the timing signal and in response to the level of lubrication required for the chain to deliver the pressurized fluid further along the line to dispense a discrete predetermined amount of the lubricating fluid from an outlet located close to and spaced from the chain, accurately onto each consecutive pin for sufficient number of revolutions of the chain for the required level of lubrication to be attained.

12. The method of claim 11 wherein the valve is closed before the next timing signal is generated.

13. The method of claim 11 wherein the conveyor chain's motor drive amperage is monitored as an estimate of the level of lubrication required for the chain.

14. The method of claim 11 wherein the conveyor chain's speed is monitored as an estimate of the level of lubrication required for the chain.

15. The method of claim 11 wherein when the conveyor chain requires a greater level of lubrication, lubricant is deposited onto each consecutive pin for an increased number of chain revolutions in succession or for a relatively increased number of chain revolutions within a given cycle of lubrication and non-lubrication.

16. The method of claim 11 wherein when the conveyor chain is adequately lubricated, lubricant is deposited on each consecutive pin for a reduced number of chain revolutions or a period of non-lubrication is started.

17. The method of claim 1, wherein when the valve is closed, lubricant is recirculated to the reservoir.
